(19) United States
(12) Patent Application Publication
(10) Pub. No.: US 2011/0141395 A1
(43) Pub. Date: Jun. 16, 2011

(54) BACKLIGHT UNIT AND LIQUID CRYSTAL DISPLAY DEVICE

(75) Inventor: Yuji Yashiro, Osaka-shi (JP)

(73) Assignee: SHARP KABUSHIKI KAISHA, Osaka-shi, Osaka (JP)

(21) Appl. No.: 13/003,577

(22) PCT Filed: May 7, 2009
(86) PCT No.: PCT/JP2009/058611

§ 371 Date: Jan. 11, 2011

(30) Foreign Application Priority Data
Jul. 22, 2008 (JP) 2008-188249

(51) Int. Cl. G02F 1/13357; F21V 7/22

(52) U.S. Cl. 349/62; 362/606

(57) ABSTRACT

Three grating piece groups (13gr.Gr.B, 13G, 13R) on the top surface (11U) of a light guide plate correspond to light of different wavelength regions, and respectively diffract and reflect light of the corresponding wavelength region, which is incident thereon at an incident angle within a specific range, back to the incoming direction of the light. The bottom surface (11B) of the light guide plate (11) is provided with a prism (15) for reflecting the backwardly diffracted and reflected light toward the top surface (11U).

### TECHNICAL FIELD

The present invention relates to a backlight unit that supplies light to a liquid crystal display panel or the like, and also relates to a liquid crystal display device that incorporates such a backlight unit.

### BACKGROUND ART

Conventionally, liquid crystal display devices incorporating a non-luminous liquid crystal display panel also incorporate a backlight unit that supplies light to the liquid crystal display panel. Such a backlight unit is expected to shine light as perpendicularly as possible into the liquid crystal display panel. The reason is that if too much light shines obliquely into the liquid crystal display panel, diminished or uneven brightness may result.

Typically, light from a light source is introduced into a single, plate-shaped light guide plate through an edge face thereof so that the light undergoes multiple reflection inside so as to eventually exit from the light guide plate through a top face thereof. In this case, inconveniently, it is difficult to make the light exit perpendicularly to the top face. Accordingly, it is difficult to make the light enter perpendicularly the liquid crystal display panel, which is disposed to cover the top face.

One modern solution is to use a light guide plate 111 that, as shown in FIG. 7, has a diffraction grating dg which makes light from a light source 122 exit in desired directions through the top face 111U (dash-and-dot-line arrows represent light). With this structure, the diffraction-transmitted light, that is, the light that is transmitted through the diffraction grating dg, is so controlled as to propagate in desired directions. It should be noted here that the diffraction grating dg has a dispersive (spectroscopic) effect, making light in different wavelength bands propagate in different directions.

As a result, as shown in FIG. 7, the diffraction grating dg splits light of different colors, such as blue (B), green (G), and red (R), in different directions. Inconveniently, this causes the light (backlight) exiting from the light guide plate 111 through the top face thereof 111U to appear not white light but split overall. This degrades the display quality on the liquid crystal display panel that receives that light.

To prevent backlight from being split in that way, in the backlight unit disclosed in Patent Document 1, as shown in FIG. 8, the diffraction-reflected light drB, drG, and drR, that is, the light directly reflected from the diffraction grating dg, is mixed with the diffraction-transmitted light dpB, dpG, and dpR, that is, the light that is transmitted through the diffraction grating dg and then reflected from a reflective sheet 142 back into the diffraction grating dg. This reduces the splitting of backlight. The principle exploited here is that the diffraction grating dg exerts opposite dispersive effects on the diffraction-reflected light and the diffraction-transmitted light.

Specifically, as shown in FIG. 8, between the diffraction-reflected light drB, drG, and drR, which is colored such as blue (B), green (G), and red (R), and the diffraction-transmitted light dpB, dpG, and dpR, which is likewise colored such as blue (B), green (G), and red (R), the diffraction-reflected light drB mixes with the diffraction-transmitted light dpR, the diffraction-reflected light drG mixes with the diffraction-transmitted light dpG, and the diffraction-reflected light drR mixes with the diffraction-transmitted light dpB.

Backlight produced in this way by mixing together light in oppositely dispersed states is less unnecessarily colored than backlight obtained from a light guide plate 111 including a diffraction grating dg with no special measure taken.

### List of Citations

### Patent Literature

Patent Document 1: JP-2006-120521 (paragraphs [0030], [0031]; FIG. 3)

### SUMMARY OF THE INVENTION

### Technical Problem

Disadvantageously, a closer study on the backlight emitted from the backlight unit disclosed in Patent Document 1 reveals the following: as shown in FIG. 8, the mixing of the diffraction-reflected light drB with the diffraction-transmitted light dpR produces mixed light with a violet tinge, the mixing of the diffraction-reflected light drG with the diffraction-transmitted light dpG produces mixed light with a green tinge, and the mixing of the diffraction-reflected light drR with the diffraction-transmitted light dpB produces mixed light with a violet tinge.

That is, the backlight from the backlight unit disclosed in Patent Document 1 contains violet- and green-tinged light, and thus cannot be said to be light with a satisfactorily high degree of whiteness.

The present invention has been made against this background, and an object of the invention is to provide a backlight unit that, even when comprising a light guide plate including a diffraction grating, produces light with a comparatively high degree of whiteness, and to provide a liquid crystal display device incorporating such a backlight unit.

### Solution to the Problem

According to one aspect of the invention, a backlight unit includes: a light source; and a light guide plate receiving light from the light source and making the light exit by subjecting the light to multiple reflection. The face of the light guide plate through which the light guide plate receives the light is called the light-receiving face, the face of the light guide plate through which the light exits is called the light-exit face, and the face of the light guide plate opposite from the light-exit face is called the bottom face.

On the light-exit face, a diffraction grating is formed that includes at least three grating ridge groups having grating ridges arranged with different periods respectively, and the three grating ridge groups correspond to light in different wavelength bands respectively. Moreover, the grating ridge groups diffraction-reflect, out of light in corresponding particular wavelength bands, only light incident thereon at incidence angles within a particular range such that the light returns to the side from which the light propagates. On the other hand, on the bottom face, a refractive optical element is formed that reflects toward the light-exit face the light thus diffraction-reflected so as to return.

With this structure, the three grating ridge groups so act that part of the light that has not been totally reflected on the light-exit face, that is, the light reaching them in corresponding particular wavelength bands at incidence angles within a particular range is diffraction-reflected in a particular direction (in such a way that the light returns to the side from which it propagates). Thus, the diffraction-reflected light in specific wavelength bands propagates while keeping comparatively high directivity; in addition, since the directivity here is uniform, the light mixes to a comparatively high degree.

Accordingly, when the light diffraction-reflected here is, for example, light in wavelength bands corresponding to the three primary colors of light, the mixed light is high-quality white light. To achieve that, it is preferable that, of the three grating ridge groups, one be a blue-light grating ridge group corresponding to a wavelength band of blue light, one be a green-light grating ridge group corresponding to a wavelength band of green light, and one be a red-light grating ridge group corresponding to a wavelength band of red light.

In addition, when diffraction-reflected light of different colors is reflected by the refractive optical element, for example, perpendicularly to the light-exit face, the light reaching the light-exit face then continues to exit perpendicularly to the light-exit face. This increase in the amount of light traveling perpendicularly to the light-exit face of the light guide plate eliminates the need for the backlight unit to include a lens sheet for condensing light.

It is preferable that the blue-, green-, and red-light grating ridge groups fulfill equation (M1) below:

d=λ/(2·nd.sin θ) Equation (M1)

where
nd represents the refractive index, for the d-line, of the material of which the diffraction grating is formed;
d represents the grating period of grating ridges that diffract light in the grating ridge groups;
λ represents the wavelength of light; and
θ represents the angle at which the incidence angle of light incident on the diffraction grating coincides with the reflection angle of diffraction-reflected light derived from the incident light.

It is preferable that the grating ridges have a height of 500 nm or more but 1000 nm or less.

It is preferable that, in addition, equations (C1) and (C2) below be fulfilled:

γ=θ±Δ Equation (C1)

γ+2·δA+2·δB=180° Equation (C2)

where
Δ(°) represents the angle, in the range of 0°<Δ<10°, within which diffraction-reflected light is produced with diffraction efficiency equal to or more than 0.5 times the diffraction efficiency of diffraction-reflected light at θ;
γ(°) is the sum of or difference between θ and Δ, and represents the reflection angle at which diffraction-reflected light is produced with diffraction efficiency equal to or more than 0.5 times the diffraction efficiency of the diffraction-reflected light at θ;
δA(°) represents, assuming that the refractive optical element is a triangular prism protruding from the bottom face to form two angles with respect thereto, whichever of those two angles is farther away from the light source; and
δB(°) represents, assuming that the refractive optical element is a triangular prism protruding from the bottom face to form two angles with respect thereto, whichever of those two angles is closer to the light source.

To maximize the amount of light exiting perpendicularly to the light-exit face, it is preferable that the backlight unit fulfill equation (C3) below:

δA<5° Condition (C3)

According to another aspect of the invention, a liquid crystal display device includes: a backlight unit as described above; and a liquid crystal display panel receiving light from the backlight unit.

### Advantageous Effects of the Invention

According to the present invention, it is possible, by use of a diffraction grating formed on the light-exit face of a light guide plate and a refractive optical element formed on the bottom face of the light guide plate, to make high-quality white light exit perpendicularly to the light-exit face.

### BRIEF DESCRIPTION OF DRAWINGS

FIG. 1 is a sectional view of the backlight unit included in the liquid crystal display device shown in FIG. 2, as cut along line A-A′ and seen from the direction indicated by arrows.

FIG. 2 is an exploded perspective view of a liquid crystal display device.

FIG. 3A is a polar coordinate diagram showing the behavior of reflected light when light with a wavelength of 470 nm is incident on a grating ridge group having grating ridges with a height of 300 nm densely arranged with a grating period of 170 nm.

FIG. 3B is a polar coordinate diagram showing the behavior of reflected light when light with a wavelength of 470 nm is incident on a grating ridge group having grating ridges with a height of 300 nm densely arranged with a grating period of 200 nm.

FIG. 3C is a polar coordinate diagram showing the behavior of reflected light when light with a wavelength of 470 nm is incident on a grating ridge group having grating ridges with a height of 300 nm densely arranged with a grating period of 230 nm.

FIG. 4A is a polar coordinate diagram showing the behavior of reflected light when light with a wavelength of 550 nm is incident on a grating ridge group having grating ridges with a height of 300 nm densely arranged with a grating period of 170 nm.

FIG. 4B is a polar coordinate diagram showing the behavior of reflected light when light with a wavelength of 550 nm is incident on a grating ridge group having grating ridges with a height of 300 nm densely arranged with a grating period of 200 nm.

FIG. 4C is a polar coordinate diagram showing the behavior of reflected light when light with a wavelength of 550 nm is incident on a grating ridge group having grating ridges with a height of 300 nm densely arranged with a grating period of 230 nm.

FIG. 5A is a polar coordinate diagram showing the behavior of reflected light when light with a wavelength of 620 nm is incident on a grating ridge group having grating ridges with a height of 300 nm densely arranged with a grating period of 170 nm.

FIG. 5B is a polar coordinate diagram showing the behavior of reflected light when light with a wavelength of 620 nm is incident on a grating ridge group having grating ridges with a height of 300 nm densely arranged with a grating period of 200 nm.

FIG. 5C is a polar coordinate diagram showing the behavior of reflected light when light with a wavelength of 620 nm is incident on a grating ridge group having grating ridges with a height of 300 nm densely arranged with a grating period of 230 nm.

FIG. 6 is an enlarged sectional view of the light guide plate shown in FIG. 1.

FIG. 7 is a sectional view of a light guide plate and a light source incorporated in a conventional backlight unit.

FIG. 8 is a sectional view of a light guide plate, a light source, and a reflective sheet incorporated in a conventional backlight unit different from the one shown in FIG. 7.

### DESCRIPTION OF EMBODIMENTS

### Embodiment 1

An embodiment of the present invention will be described below with reference to the accompanying drawings. For convenience' sake, hatching, reference signs, etc. do not necessarily appear in all relevant drawings, in which case reference is to be made to those drawings in which they appear. A solid black dot in a drawing indicates the direction perpendicular to the plane of the paper.

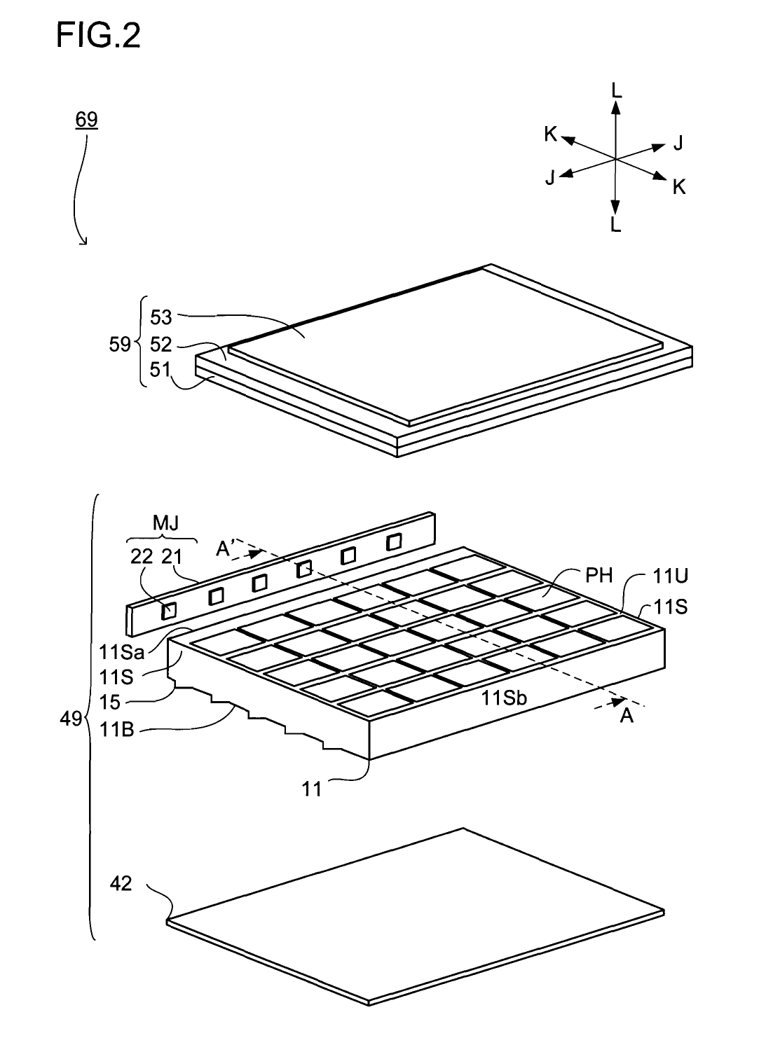

FIG. 2 is an exploded perspective view of a liquid crystal display device 69. As shown there, the liquid crystal display device 69 comprises a liquid crystal display panel 59 and a backlight unit 49.

The liquid crystal display panel 59 is composed of an active matrix substrate 51, which includes switching elements such as TFTs (thin-film transistors), and a counter substrate 52, which faces the active matrix substrate 51, stuck together by a sealing member (not shown). The gap between the two substrates 51 and 52 is filled with liquid crystal (not shown). (The active matrix substrate 51 and the counter substrate 52 are sandwiched between polarizing films 53 and 53.)

The liquid crystal display panel 59 is of a non-luminous type, and achieves display by receiving light (backlight) from the backlight unit 49. Accordingly, illuminating the entire surface of the liquid crystal display panel 59 evenly with the light from the backlight unit 49 contributes to enhanced display quality on the liquid crystal display panel 59.

The backlight unit 49 includes an LED module (light source module) MJ, a light guide plate 11, and a reflective sheet 42.

The LED module MJ is a module that emits light; it includes a mount substrate 21 and an LED (light-emitting diode) 22, the latter being mounted on electrodes formed on a mounting surface of the former to receive electric current to emit light.

Preferably, to secure a necessary amount of light, the LED module MJ comprises a plurality of LEDs (point light sources) 22 as light-emitting elements. Preferably, these LEDs 22 are disposed in a row. For convenience' sake, only part of the LEDs 22 are shown in the drawing (in the following description, the direction of the row of the LEDs 22 is also referred to as J direction).

The light guide plate 11 is a plate-shaped member having edge faces 11S, a top face 11U, and a bottom face 11B, the latter two being so located as to sandwich the former. Of all the edge faces 11S, one (light-receiving face 11Sa) faces the light-emission face of the LED 22 to receive light therefrom. The light received undergoes multiple reflection inside the light guide plate 11 and eventually travels out of it, as planar light, through the top face (light-exit face) 11U. In the following description, the edge face 115 opposite from the light-receiving face 11Sa is referred to as the opposite face 11Sb, and the direction pointing from the light-receiving face 11Sa to the opposite face 11Sb is referred to as K direction (the light guide plate 11 will be described in more detail later).

The reflective sheet 42 is so located as to be covered by the light guide plate 11. The face of the reflective sheet 42 facing the bottom face 11B of the light guide plate 11 is a reflective surface. This reflective surface reflects the light from the LED 22 and the light propagating inside the light guide plate 11 back into the light guide plate 11 (through the bottom face 11B of the light guide plate 11) without letting it leak out.

In the backlight unit 49 described above, the reflective sheet 42 and the light guide plate 11 are stacked in this order (the direction in which they are stacked is referred to as L direction; it is preferable that J, K, and L directions be perpendicular to one another). The light from the LED 22 is turned by the light guide plate 11 into, and emanates therefrom as, planar light (backlight). The planar light reaches the liquid crystal display panel 59, and permits it to display an image.

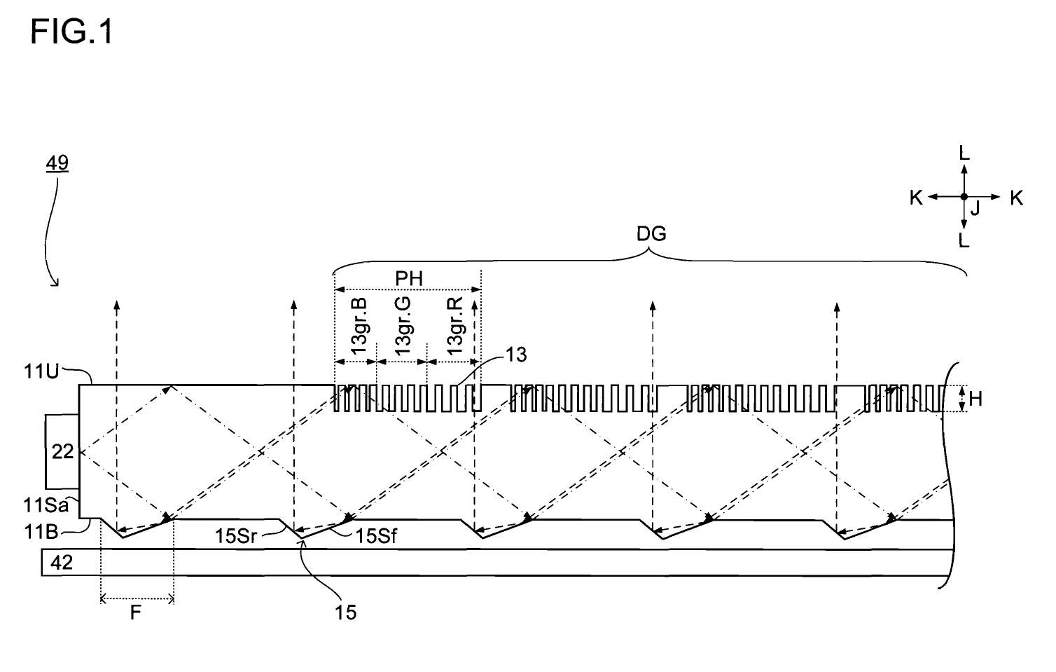

Now, the light guide plate 11 in the backlight unit 49 will be described in detail with reference to FIG. 1. FIG. 1 is a sectional view of the backlight unit 49 shown in FIG. 2, as cut along line A-A′ and seen from the direction indicated by arrows. In FIG. 1, the diffraction-reflected light of order −1 (part of the light that does not undergo total reflection at the top face 11U), which will be described later, is indicated by broken-line arrows, and the totally reflected and other light is indicated by dash-and-dot-line arrows.

As shown in FIG. 1, on the top face 11U of the light guide plate 11, a diffraction grating DG is formed which has densely arranged grating ridges 13. The diffraction grating DG is designed by a well-known RCWA (rigorous coupled wave analysis) method and according to equation (MO) noted below so as to produce diffraction-reflected light of comparatively high light intensity (diffraction-reflected light of order −1).

n2·sin θ2=n1·sin θ1+m·λ/d (M0)

where
n1 represents the refractive index of the medium on the incidence side of the top face 11U;
θ1(°) represents the angle of light incident on the top face 11U with respect to the top face 11U (this angle will be referred to as the incidence angle);
n2 represents the refractive index of the medium on the emergence side of the top face 11U;
θ2(°) represents the angle of light reflected on the top face 11U with respect to the top face 11U (this angle will be referred to as the reflection angle);
d(nm) represents the periodic interval of the diffraction grating DG;
m represents the order of diffraction; and
λ represents the wavelength of light.
   (For easier understanding of θ1 and θ2, consider them to be angles that are measured on KL plane defined by K and L directions.)

For a case where the incidence and emergence sides with respect to the top face 11U are both the light guide plate 11, equation (M0) can be given as equation (M0′) below.

n1·sin θ2=n1·sin θ1+m·λ/d (M0′)

Specifically, the diffraction grating DG so designed has, as shown in FIG. 1, a plurality of grating ridges 13 in the shape of parallelepipeds (blocks), and these grating ridges 13 are located on the top face 11U of the light guide plate 11. The grating ridges 13 are arranged with varying periods (pitches, grating periods).

For example, in a case where the light guide plate 11 is formed of polycarbonate (with a refractive index nd of 1.59), the distance from the base to the tip of the grating ridges 13, that is, the height (H) of the grating ridges 13, is 300 nm, and these grating ridges 13 are arranged with three different periods d (dB, dG, and dR=170 nm, 200 nm, and 230 nm respectively). The grating ridges 13 arranged with each period d (dB, dG, and dR) are densely located to form a grating ridge group 13gr (13gr.B, 13gr.G, and 13gr.R respectively), and a group of grating ridge groups 13gr.B, 13gr.G, and 13gr.R having grating ridges arranged with different periods forms one patch PH (see FIG. 2; each patch is rectangular in shape and measures about 10 nm by 10 μm). In each patch PH (hence, in the diffraction grating GS), the grating ridge groups 13gr.B, 13gr.G, and 13gr.R are arranged one adjacent to another in the direction pointing from the light-receiving face 11Sa to the opposite face 11Sb, that is, in K direction.

When light comprising blue light (with a wavelength of about 470 nm), green light (with a wavelength of about 550 nm), and red light (with a wavelength of about 620 nm) is incident, at an incidence angle (θ1) of about 60°, on the top face 11U of the diffraction grating DG, where a number of such patches PH are arranged, the light is diffraction-reflected on the diffraction grating DG to become diffraction-reflected light having a reflection angle (θ2) equal to the incidence angle, that is, about 60°. Here, the diffraction-reflected light propagates in such a way as to return to the side from which the incident light propagates toward the diffraction grating DG. That is, the diffraction grating DG diffraction-reflects part of the light reaching it (light incident thereon at incidence angles within a particular range) in such a way as to return it to the side from which it propagates.

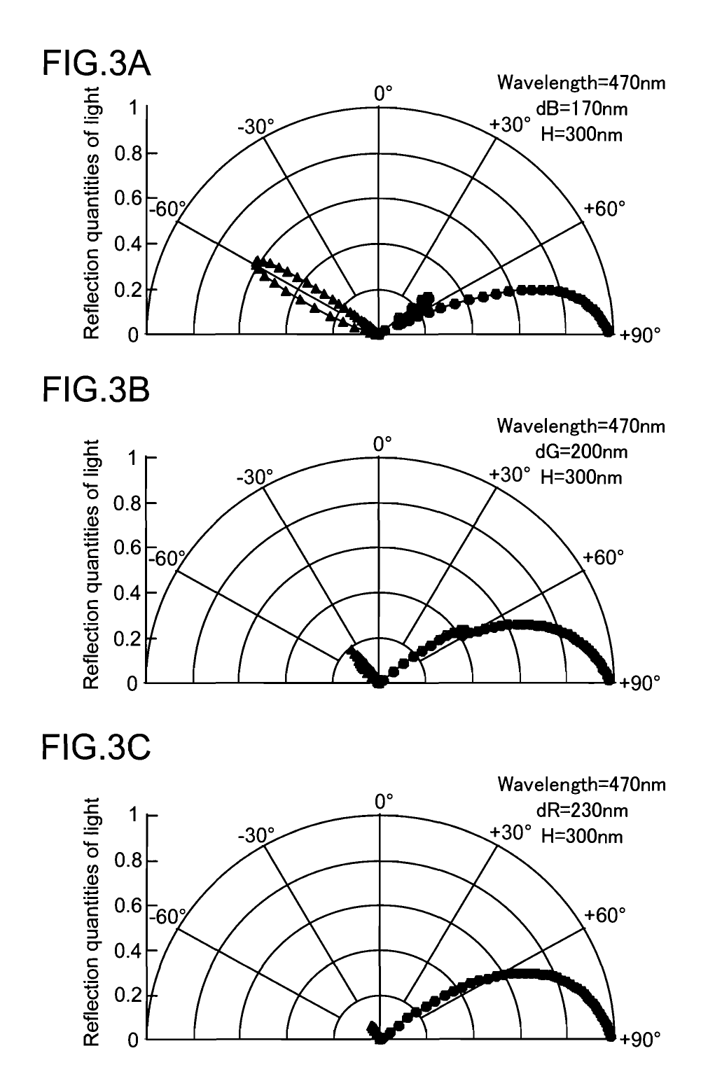

The results of the diffraction-reflection are shown in FIGS. 3A to 5C. In these diagrams, the origin of the polar coordinate system represents the point at which light is incident on the diffraction grating DG located on the top face 11U, and the angle in the polar coordinate system represents the reflection angle of the light reflected at the incidence point with respect to the top face 11U. For convenience' sake, the reflection angle of light propagating away from the LED 22 (propagating forward) is given a positive sign “+,” and the reflection angle of light propagating toward the LED 22 (propagating backward) is given a negative sign “−.” Circular dots indicate the totally reflected light, and triangular dots indicate diffraction-reflected light of order −1.

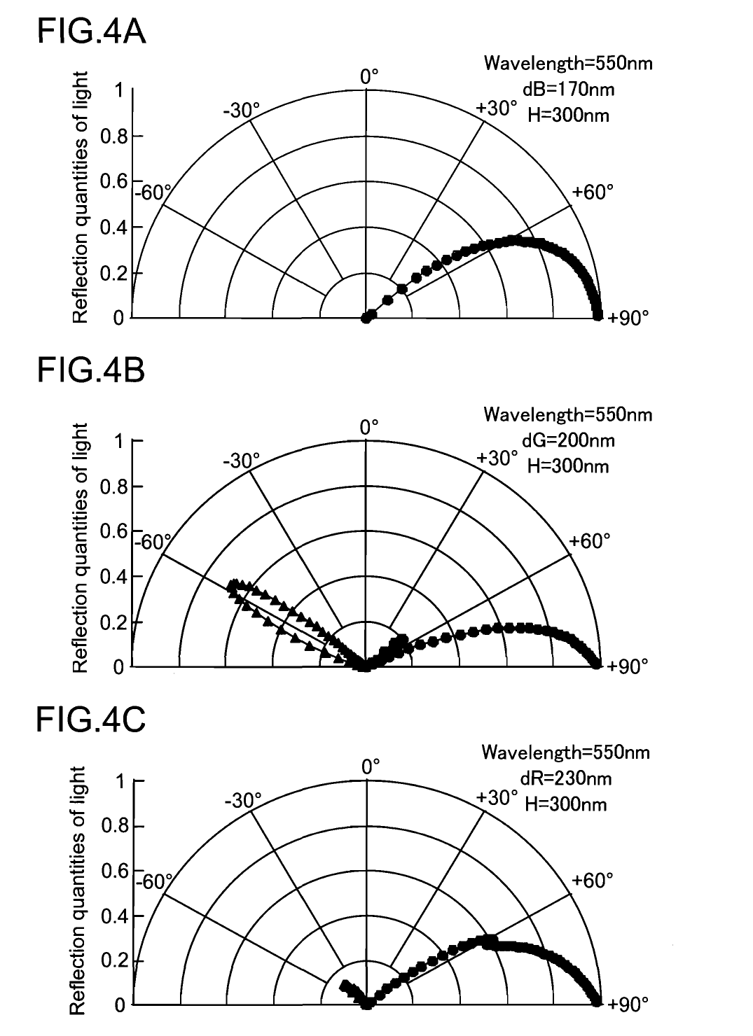

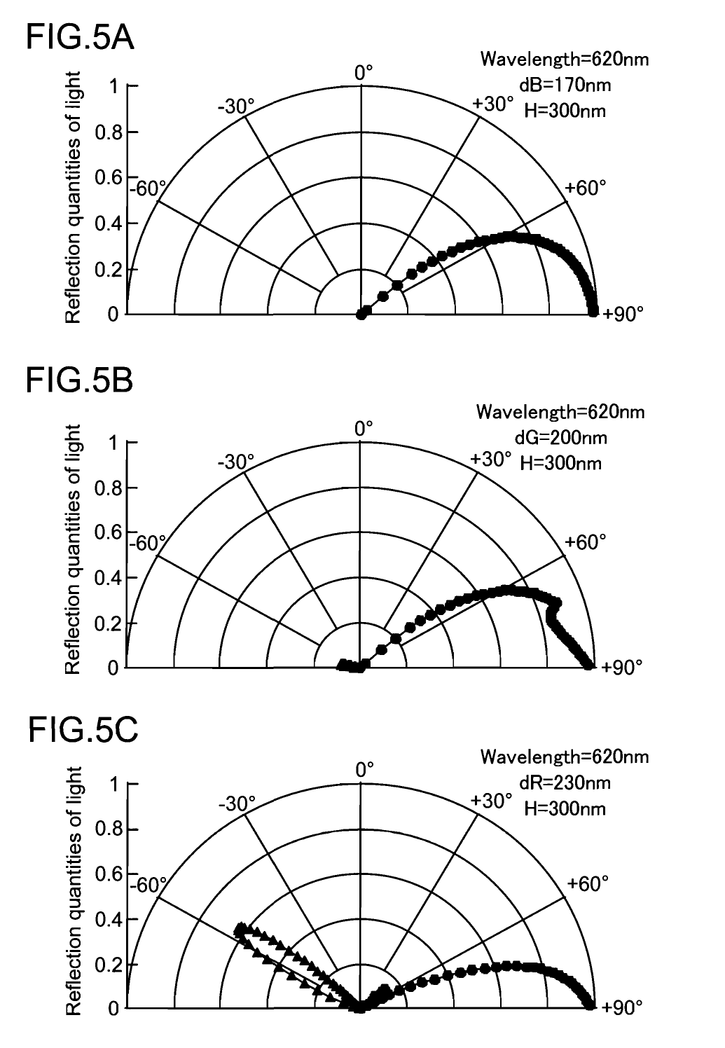

FIGS. 3A to 5C are grouped as follows. FIGS. 3A to 3C show how blue light (with a wavelength of 470 nm) behaves when it reaches the diffraction grating DG; FIGS. 4A to 4C show how green light (with a wavelength of 550 nm) behaves when it reaches the diffraction grating DG; and FIGS. 5A to 5C show how red light (with a wavelength of 620 nm) behaves when it reaches the diffraction grating DG.

FIGS. 3A, 4A, and 5A show how light behaves when it reaches the grating ridge group 13gr.B arranged with a period (grating period) dB of 170 nm; FIGS. 3B, 4B, and 5B show how light behaves when it reaches the grating ridge group 13gr.G arranged with a period (grating period) dG of 200 nm; and FIGS. 3C, 4C, and 5C show how light behaves when it reaches the grating ridge group 13gr.R arranged with a period (grating period) dR of 230 nm.

FIGS. 3A to 3C reveal the following. FIG. 3A, in particular, shows that, when blue light reaches, at an incidence angle of about 60° (θ1≈60°), the grating ridge group 13gr.B arranged with a period (grating period) dB of 170 nm, it produces totally reflected light and diffraction-reflected light of order −1. The diffraction-reflected light of order −1 has a reflection angle of about −60° (θ2≈60°. On the other hand, FIGS. 3B ad 3C show that, when blue light reaches the grating ridge groups 13gr.G and 13Gr.R arranged with periods other than 170 nm, it is for the most part totally reflected.

FIGS. 4A to 4C reveal the following. FIG. 4B, in particular, shows that, when green light reaches, at an incidence angle of about 60° (θ1≈60°), the grating ridge group 13gr.G arranged with a period (grating period) dG of 200 nm, it produces totally reflected light and diffraction-reflected light of order −1. The diffraction-reflected light of order −1 has a reflection angle of about −60° (θ2 ≈60°). On the other hand, FIGS. 4A ad 4C show that, when green light reaches the grating ridge groups 13gr.B and 13Gr.R arranged with periods other than 200 nm, it is for the most part totally reflected.

FIGS. 5A to 5C reveal the following. FIG. 5C, in particular, shows that, when red light reaches, at an incidence angle of about 60° (θ1≈60°), the grating ridge group 13gr.R arranged with a period (grating period) dR of 230 nm, it produces totally reflected light and diffraction-reflected light of order −1. The diffraction-reflected light of order −1 has a reflection angle of about −60° (θ2≈60°). On the other hand, FIGS. 5B ad 5C show that, when red light reaches the grating ridge groups 13gr.B and 13Gr.G arranged with periods other than 230 nm, it is for the most part totally reflected.

From the above-discussed results shown in FIGS. 3A to 5C, it is seen that, when conditions (A1) to (A5) noted below are fulfilled, white light propagating from the LED 22 and incident on the diffraction grating DG at an angle of about 60° (θ1≈60°) behaves in the following manner: the blue, green, and red light contained in the white light from the LED 22 and incident on the diffraction grating DG produces diffraction-reflected light of order −1 that propagates in such a way as to return to the side from which the incident light propagates toward the diffraction grating DG, and in addition all in the same direction (so as to propagate at approximately the same reflection angle θ2 (≈60°)).

nd=1.59 Condition (A1)

dB=170 nm Condition (A2)

dG=200 nm Condition (A3)

dR=230 nm Condition (A4)

H=300 nm Condition (A5)

where
nd represents the refractive index, for the d-line, of the material of which the diffraction grating DG is formed;
dB represents the grating period of the grating ridges 13 of the grating ridge group 13gr.B, which diffracts blue light;
dG represents the grating period of the grating ridges 13 of the grating ridge group 13gr.G, which diffracts green light;
dR represents the grating period of the grating ridges 13 of the grating ridge group 13gr.R, which diffracts red light; and
H represents the distance from the base to the tip of the grating ridges 13 (the height of the grating ridges 13).

In this way, the diffraction grating DG diffraction-reflects, into diffraction-reflected light of order −1, light (blue, green, and red light) in particular wavelength bands corresponding to the periods of the grating ridges 13 of the diffraction grating DG itself, and makes the diffraction-reflected light of different colors propagate all in the same direction. This makes it easy to mix blue, green, and red light. That is, blue, green, and red light with uniform directivity is mixed to produce high-quality white light.

The reflection angle of the light incident on the diffraction grating DG, which has been mentioned to be about 60°, is, in more specific numerical examples, 60°, 55°, and 65°, for instance. When light incident at these incidence angles is reflected as diffraction-reflected light of order −1, the reflection angle is as follows: for an incidence angle of 60°, a reflection angle of −60°; for an incidence angle of 55°, a reflection angle of −65.56°; and for an incidence angle of 65°, a reflection angle of −55.41°.

The phenomenon described above can be summarized as follows: diffraction efficiency is high when diffraction-reflected light of order −1 is reflected in the direction (reflection angle) opposite from the direction (incidence angle) from which the source light is incident on the diffraction grating GS. Accordingly, in equation (M0′), the following substitutions are possible: θ1=−θ2=θ (θ will be described later); and m=−1. Thus, equation (M1) below is derived.

Moreover, the grating periods (nm) of the grating ridges 13 that diffract light in the grating ridge groups 13gr.B, 13gr.G, and 13gr.R are about half the wavelengths of visible light in the corresponding wavelength bands. Moreover, the height (H) of the grating ridges 13 is determined based on its correlation with the diffraction efficiency found by an RCWA (rigorous coupled wave analysis) method (the height of the grating ridges 13 is typically 50 nm or more but 1000 nm or less).

d=λ/(2·nd·sin θ) Equation (M1)

where
nd represents the refractive index, for the d-line, of the material of which the diffraction grating GS is formed;
d represents the grating period (nm) of the grating ridges 13 that diffract light in the grating ridge groups 13gr.B, 13gr.G, and 13gr.R;
λ represents the wavelength (nm) of light; and
θ represents the angle (°) at which the incidence angle of light incident on the diffraction grating GS coincides with the reflection angle of the diffraction-reflected light derived from that light.

As shown in FIG. 1, the above-described high-quality white light after reflection propagates backward in such a way as to return to the LED 22 side (it is reflected backward). That is, inside the light guide plate 11, whereas the light that reaches the diffraction grating DG while traveling toward the opposite face 11Sb by undergoing multiple reflection travels from the light-receiving face 11Sa to the opposite face 11Sb (forward), the light that is reflected on the diffraction grating DG to become diffraction-reflected light of order −1 travels in the opposite direction (from the opposite face 11Sb to the light-receiving face 11Sa, backward).

This diffraction-reflected light of order −1 (the light diffraction-reflected backward on the diffraction grating DG) then needs to be directed to the top face 11U, and for this purpose a prism 15 (refractive optical element) is formed on the bottom face 11B of the light guide plate 11. The prism 15 is a triangular prism; as shown in FIG. 1, it protrudes from the bottom face 11B of the light guide plate 11 to have two prism faces (side faces) (a front prism face 15Sf and a rear prism face 15Sr) inclined with respect to the bottom face 11B.

Of these two prism faces, the one closer to the opposite face 11Sb of the light guide plate 11 (farther away from the LED 22), that is, the front prism face 15Sf, is so located as to receive the diffraction-reflected light of order −1 from the diffraction grating DG. Moreover, the front prism face 15Sf is so inclined as to reflect the received diffraction-reflected light of order −1 toward the rear prism face 15Sr, that is, the other of the two prism faces which is closer to the light-receiving face 11Sa of the light guide plate 11 (closer to the LED 22).

The rear prism face 15Sr is so located as to receive the diffraction-reflected light of order −1 from the front prism face 15Sf. Moreover, the rear prism face 15Sr is so inclined as to reflect the received diffraction-reflected light of order −1 toward the top face 11U.

Preferably, the rear prism face 15Sr is so inclined as to reflect the diffraction-reflected light of order −1 perpendicularly to the top face 11U. To achieve that, it is preferable that the prism 15 be formed so as to fulfill equations (C1) and (C2) below.

γ=θ±Δ Equation (C1)

γ+2·δA+2·δB=180° Equation (C2)

where
θ(°) represents the angle at which the incidence angle of light incident on the diffraction grating GS coincides with the reflection angle of the diffraction-reflected light derived from that light;
Δ(°) represents an angle, in the range of 0°<Δ<10°, within which diffraction-reflected light is produced with diffraction efficiency equal to or more than 0.5 times the diffraction efficiency of the diffraction-reflected light at θ;
γ(°) is the sum of or difference between θ and Δ, and represents the reflection angle at which diffraction-reflected light is produced with diffraction efficiency equal to or more than 0.5 times the diffraction efficiency of the diffraction-reflected light at θ;
δA(°) represents, assuming that the prism 15 is a triangular prism protruding from the bottom face 11B to form two angles with respect thereto, whichever of those two angles is farther away from the LED 22; and
δB(°) represents, assuming that the prism 15 is a triangular prism protruding from the bottom face 11B to form two angles with respect thereto, whichever of those two angles is closer to the LED 22.

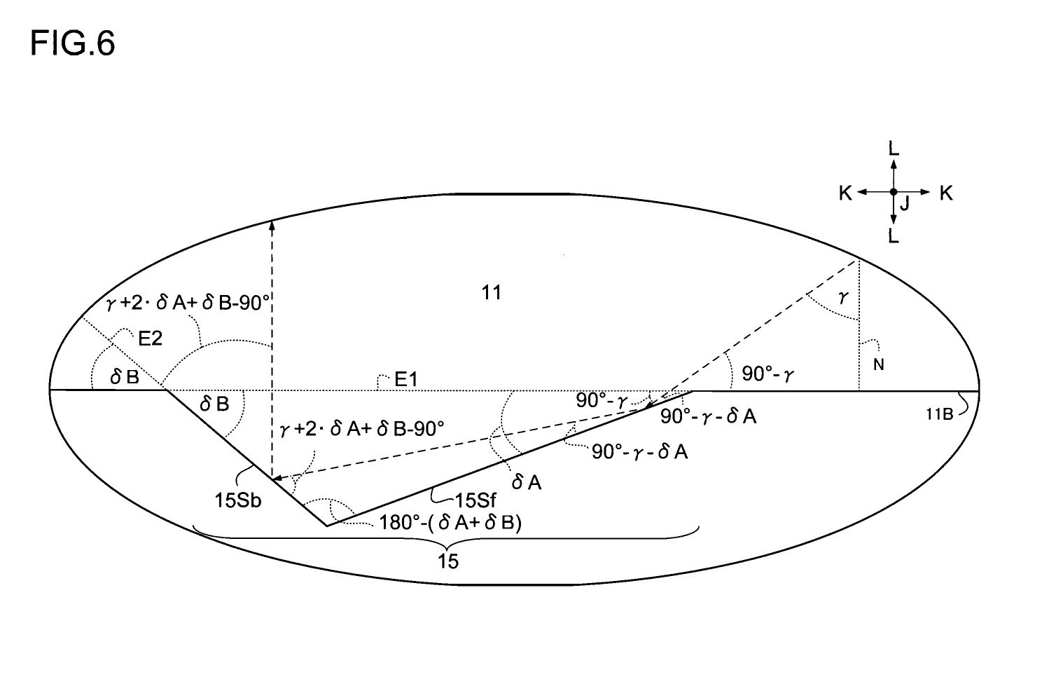

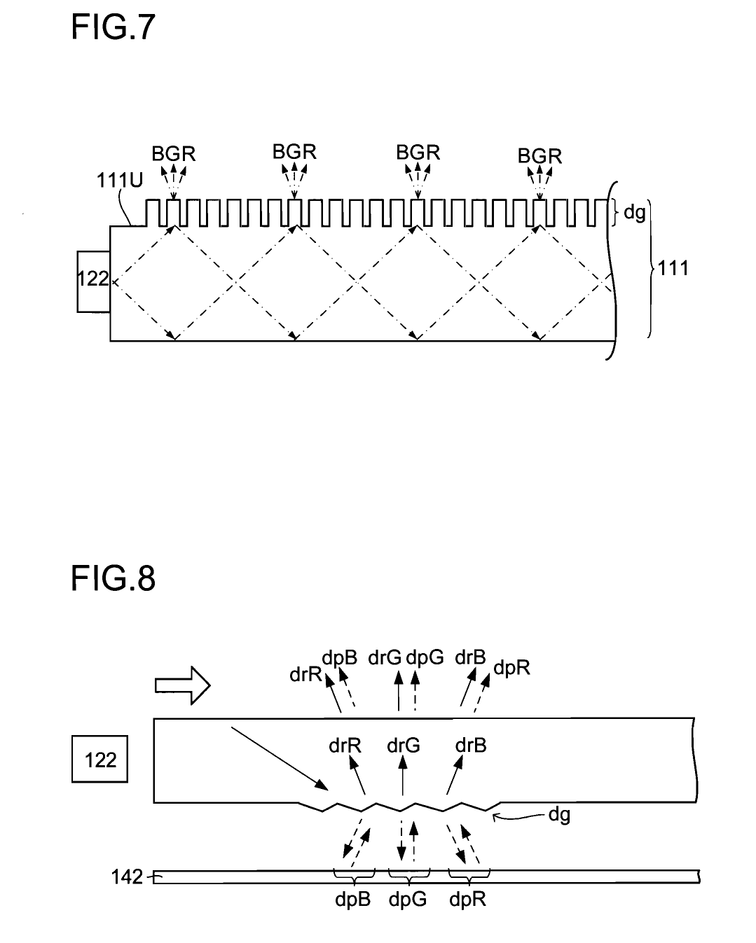

These equations (C1) and (C2) will now be described with reference to an enlarged sectional view in FIG. 6. There, as in FIG. 1, broken-line arrows indicate the diffraction-reflected light of order −1.

The diffraction-reflected light of order −1 traveling toward the prism 15 has a reflection angle of “γ.” Consider a first imaginary triangle which has a first side along the diffraction-reflected light of order −1 until reaching the prism 15, a second side along a line N normal to the bottom face 11B (and the top face 11U), and a third side along a first extension plane E1 which is an extension of the bottom face 11B into the prism 15. The first imaginary triangle then has angles of “γ” and 90°. The third angle thus equals “90°−γ.” This third angle is vertically opposite to the angle formed between the first extension plane E1 and the diffraction-reflected light of order −1. Thus, the angle formed between the first extension plane E1 and the diffraction-reflected light of order −1 also equals “90°−γ.”

Consider a second imaginary triangle which has a first side along the front prism face 15Sf, a second side along the diffraction-reflected light of order −1 traveling toward the front prism face 15Sf, and a third side along the first extension plane E1. In this second imaginary triangle, the angle formed between the front prism face 15Sf and the diffraction-reflected light of order −1 equals “δA” subtracted from the angle formed between the first extension plane E1 and the diffraction-reflected light of order −1, namely “90°−γ” (that is, “90°−γ−δA”).

Assume that the diffraction-reflected light of order −1 incident on the front prism face 15Sf is totally reflected, and consider a third imaginary triangle which has a first side along the totally reflected diffraction-reflected light of order −1, a second side along the front prism face 15Sf, and a third side along the rear prism face 15Sb. In this third imaginary triangle, the angle formed between the totally reflected diffraction-reflected light of order −1 and the front prism face 15Sf also equals “90°−γ−δA.”

Moreover, in the third imaginary triangle, the angle formed between the front prism face 15Sf and the rear prism face 15Sb equals, as dictated by the shape of the triangular prism, “180°−(δA+δB).” Then, the third angle in the third imaginary triangle, that is, the angle formed between the totally reflected diffraction-reflected light of order −1 and the rear prism face 15Sb, equals “γ+2·δA+δB−90°.”

When the diffraction-reflected light of order −1 propagating from the front prism face 15Sf is totally reflected on the rear prism face 15Sb, the angle formed between the diffraction-reflected light of order −1 that has thus been totally reflected for the second time and the rear prism face 15Sb also equals “γ+2·δA+δB−90°.” Moreover, of the angles formed between a second extension plane E2 which is an extension from the rear prism face 15Sb and the bottom face 11B, the one vertically opposite to the angle “δB” in the prism 15 equals “δB.”

Then, the sum of the angle formed between the second extension plane E2 and the bottom face 11B and the angle formed between the diffraction-reflected light of order −1 that has been totally reflected for the second time and the rear prism face 15Sb (“γ+2·δA+2·δB−90°”) is the reflection angle of the diffraction-reflected light of order −1 that has been totally reflected for the second time with respect to the bottom face 11B (hence the top face 11U). Accordingly, when this sum “γ+2·δA+2·δB−90°” equals 90°, the diffraction-reflected light of order −1 from the diffraction grating DG exits perpendicularly to the top face 11U.

That is, when the prism 15 is designed to fulfill equation (C2), “γ+2·δA+2·δB=180°,” derived from “γ+2·δA+2·δB−90°=90°,” the diffraction-reflected light of order −1 from the diffraction grating DG exits perpendicularly to the top face 11U.

With this structure, the diffraction-reflected light of order −1, containing blue, green, and red light, from the diffraction grating DG reaches the prism 15 in a state mixed to a comparatively high degree, and is then guided by the prism 15 to travel and exit perpendicularly to the top face 11U. Thus, the backlight unit 49 no longer requires a lens sheet for condensing light, and this helps reduce cost.

In a specific numerical example of the prism 15, the relevant parameters have the following values:

δA=4°;

δB=58.5°;

F=10 μm

where
F represents the width of the prism 15 (the length of the prism 15 in K direction) formed on the bottom face 11B of the light guide plate 11.

If the angle δA is equal to or greater than 5°, part of the diffraction-reflected light of order −1 that propagates in such a way as to return toward the prism 15, in particular light having comparatively small reflection angles (θ2), is less likely, after being reflected on the front prism face 15Sf, to travel toward the rear prism face 15Sb. Rather, light reaching the front prism face 15Sf at comparatively small reflection angles (θ2) is reflected to travel, not toward the rear prism face 15Sb, but toward the bottom face 11B.

An increase in the amount of such light results in a decrease in the amount of light reaching the rear prism face 15Sb, and hence a decrease in the amount of light exiting upright through the top face 11U. For this reason, it is preferable that condition (C3) below be fulfilled.

δA<5° Condition (C3)

Even if part of the diffraction-reflected light of order −1 happens to be transmitted through the prism 15, it is reflected by the reflective sheet 42 back to the bottom face 11B of the light guide plate 11.

### OTHER EMBODIMENTS

It should be understood that the present invention may be carried out in any other manners than specifically described by way of an embodiment above and allows for many modifications and variations without departing from the spirit of the invention.

For example, although the foregoing description mentions, as an example of the material of the light guide plate 11, polycarbonate fulfilling conditions (A1) to (A5) and equation (M1) noted above, this is not meant to be any limitation. The light guide plate 11 may instead be formed of, for example, silicone resin. Even in that case, in particular when the light guide plate 11 fulfills conditions (B1) to (B5) below, it permits light to behave as shown in FIGS. 3A to 5C (it should be noted that when conditions (B1) to (B5) hold, equation (M1) also holds).

nd=1.3 Condition (B1)

dB=210 nm Condition (B2)

dG=245 nm Condition (B3)

dR=270 nm Condition (B4)

H=300 nm Condition (B5)

Also with this light guide plate 11 formed of silicone resin, the grating ridge groups 13gr.B, 13gr.G, and 13gr.R so act that the light reaching them in corresponding particular wavelength bands at incidence angles within a particular range (about 60°) is diffraction-reflected in a particular direction, that is, at a reflection angle of about 60° (in such a way that the light returns to the side from which it propagates).

Thus, the diffraction-reflected light in specific wavelength bands propagates while keeping comparatively high directivity; in addition, since the directivity here is uniform, the light mixes to a comparatively high degree. Accordingly, when the light diffraction-reflected here is light in wavelength bands corresponding to the three primary colors of light, the mixed light is high-quality white light. In this way, the same effect is obtained as with the light guide plate 11 of Embodiment 1 which is formed of polycarbonate and includes the diffraction grating DG; that is, high-quality white light is produced.

Also with this light guide plate 11 formed of silicone resin, a specific numerical example in which the incidence angle of light incident on the diffraction grating DG is about 60° is similar to one involving the light guide plate 11 of polycarbonate. Specifically, when the incidence angle of light incident on the diffraction grating DG is 60°, the reflection angle of the diffraction-reflected light of order −1 is −60°; when the incidence angle is 55°, the reflection angle is −65.56°; and when the incidence angle is 65°, the reflection angle is −55.41°.

Also with this light guide plate 11 formed of silicone resin, when equations (C1) and (C2) are fulfilled, the diffraction-reflected light of order −1 from the diffraction grating DG exits perpendicularly to the top face 11U. Thus, the diffraction-reflected light of order −1, containing blue, green, and red light, from the diffraction grating DG reaches the prism 15 in a state mixed to a comparatively high degree, and is then guided by the prism 15 to travel and exit perpendicularly to the top face 11U.

In this way, as a result of diffraction-reflected light of different colors being reflected by the prism 15 so as to travel perpendicularly to the top face 11U, the light exiting from the light guide plate 11 has a directivity perpendicular to the light guide plate 11. Thus, even when incorporating such a light guide plate 11 formed of silicone, the backlight unit 49 does not require a lens sheet for condensing light, and this helps reduce cost.

In summary, the light guide plate 11 has, formed on its top face 11U, the diffraction grating DG which returns the light reaching the face to the side from which the light propagates; moreover the light guide plate 11 has, formed on its bottom face 11B, the prism 15 which reflects the thus backward diffraction-reflected light toward the top face 11U. So long as these requirements are met, no specific conditions matter.

Accordingly, there are no particular limitations on the refractive indices of the materials of the light guide plate 11, the diffraction grating DG, and the prism 15, and the grating ridges 13 may be, instead of in the shape of parallelepipeds, cylindrical, conical, etc. The grating periods of the grating ridges 13 may be other than about half the wavelengths of visible light in specific wavelength bands. Needless to say, the height of the grating ridges 13 is not limited to 300 nm, which is mentioned above as a mere example.

In a specific numerical example of the above-described prism 15 formed of silicone resin, the relevant parameters have the following values:

δA=3°;

δB=59.5°;

F=10 μm.

It is here preferable that, instead of condition (C3) noted previously, condition (C4) below be fulfilled. Fulfilling this condition (C4) gives an effect similar to that obtained by fulfilling condition (C3).

δA<4° Condition (C4)

From the numerical examples of the prism 15 formed of polycarbonate and that formed of silicone resin, equation (C5) below is also derived. Specifically, when this condition (C5) holds, the prism 15 reflects the diffraction-reflected light of order −1 propagating from the diffraction grating DG such that it exits perpendicularly to the top face 11U.

δA+δB=62.5° Condition (C5)

Although the above description takes up an LED 22 as a light source, this is not meant to be any limitation. Instead, it is possible to use a linear light source such as a fluorescent lamp, or a light source based on a self-luminous material such as one producing organic or inorganic EL (electro-luminescence).

Although the above description deals with a case where the diffraction grating DG includes three grating ridge groups 13gr, it may instead include more grating ridge groups 13gr. In a case where white light is produced by mixing light in four or more specific wavelength bands, the diffraction grating DG may include four or more grating ridge groups 13gr.

Although the above description takes up a prism 15 as an optical element for guiding the diffraction-reflected light of order −1 to the top face 11U, this is not meant to be any limitation. Instead, it is possible to use a mirror.

### LIST OF REFERENCE SIGNS

11 Light guide plate

11B Bottom face of the light guide plate

11U Top face of the light guide plate (light-exit face)

11S Side face of the light guide plate

11Sa Light-receiving face of the light guide plate

11Sb Side face of the light guide plate opposite from the light-receiving face, that is, opposite face

13 Grating ridges

13gr.B Grating ridge group corresponding to blue light (blue-light grating ridge group)

13gr.G Grating ridge group corresponding to green light (green-light grating ridge group)

13gr.R Grating ridge group corresponding to red light (red-light grating ridge group)

PH Diffraction grating patch

DG Diffraction grating

15 Prism (refractive optical element)

15S Face of the prism

15Sf Front prism face (prism face farther away from the light source)

15Sr Rear prism face (prism face closer to the light source)

21 Mount substrate

22 LED (light source)

42 Reflective sheet

49 Backlight unit

59 Liquid crystal display panel

69 Liquid crystal display device

1. A backlight unit comprising:
a light source; and
a light guide plate receiving light from the light source and making the light exit by subjecting the light to multiple reflection,
wherein
let a face of the light guide plate through which the light guide plate receives the light be called a light-receiving face, let a face of the light guide plate through which the light exits be called a light-exit face, and let a face of the light guide plate opposite from the light-exit face be called a bottom face, then
on the light-exit face, a diffraction grating is formed that includes at least three grating ridge groups having grating ridges arranged with different periods respectively,
the three grating ridge groups correspond to light in different wavelength bands respectively,
the grating ridge groups diffraction-reflect, out of light in corresponding particular wavelength bands, only light incident thereon at incidence angles within a particular range such that the light returns to a side from which the light propagates, and
on the bottom face, a refractive optical element is formed that reflects toward the light-exit face the light thus diffraction-reflected so as to return.

2. The backlight unit according to claim 1, wherein
of the three grating ridge groups, one is a blue-light grating ridge group corresponding to a wavelength band of blue light, one is a green-light grating ridge group corresponding to a wavelength band of green light, and one is a red-light grating ridge group corresponding to a wavelength band of red light.

3. The backlight unit according to claim 2, wherein
the blue-, green-, and red-light grating ridge groups fulfill equation (M1) below:
d=λ/(2·nd·sin θ) Equation (M1)
where
nd represents a refractive index, for a d-line, of a material of which the diffraction grating is formed;
d represents a grating period of grating ridges that diffract light in the grating ridge groups;
λ represents a wavelength of light; and
θ represents an angle at which an incidence angle of light incident on the diffraction grating coincides with a reflection angle of diffraction-reflected light derived from the incident light.

4. The backlight unit according to claim 2, wherein
the grating ridges have a height of 500 nm or more but 1000 nm or less.

5. The backlight unit according to claim 3, wherein
equations (C1) and (C2) below are fulfilled:
γ=θ±Δ Equation (C1)
γ+2·δA+2·δB=180° Equation (C2)
where
Δ(°) represents an angle, in a range of 0°<Δ<10°, within which diffraction-reflected light is produced with diffraction efficiency equal to or more than 0.5 times diffraction efficiency of diffraction-reflected light at θ;
γ(°) is a sum of or difference between θ and Δ, and represents a reflection angle at which diffraction-reflected light is produced with diffraction efficiency equal to or more than 0.5 times diffraction efficiency of the diffraction-reflected light at θ;
δA(°) represents, assuming that the refractive optical element is a triangular prism protruding from the bottom face to form two angles with respect thereto, whichever of those two angles is farther away from the light source; and
δB(°) represents, assuming that the refractive optical element is a triangular prism protruding from the bottom face to form two angles with respect thereto, whichever of those two angles is closer to the light source.

6. The backlight unit according to claim 5, wherein equation (C3) below is fulfilled:
δA<5° Condition (C3)

7. A liquid crystal display device comprising:
the backlight unit according to claim 1; and
a liquid crystal display panel receiving light from the backlight unit.

8. The backlight unit according to claim 3, wherein
the grating ridges have a height of 500 nm or more but 1000 nm or less.

9. The backlight unit according to claim 4, wherein equations (C1) and (C2) below are fulfilled:
γ=θ±Δ Equation (C1)
γ+2·δA+2·δB=180° Equation (C2)
where
Δ(°) represents an angle, in a range of 0°<Δ<10°, within which diffraction-reflected light is produced with diffraction efficiency equal to or more than 0.5 times diffraction efficiency of diffraction-reflected light at θ;
γ(°) is a sum of or difference between θ and Δ, and represents a reflection angle at which diffraction-reflected light is produced with diffraction efficiency equal to or more than 0.5 times diffraction efficiency of the diffraction-reflected light at θ;
δA(°) represents, assuming that the refractive optical element is a triangular prism protruding from the bottom face to form two angles with respect thereto, whichever of those two angles is farther away from the light source; and
δB(°) represents, assuming that the refractive optical element is a triangular prism protruding from the bottom face to form two angles with respect thereto, whichever of those two angles is closer to the light source.

10. The backlight unit according to claim 8, wherein equations (C1) and (C2) below are fulfilled:
γ=θ±Δ Equation (C1)
γ+2·δA+2·δB=180° Equation (C2)
where
Δ(°) represents an angle, in a range of 0°<Δ<10°, within which diffraction-reflected light is produced with diffraction efficiency equal to or more than 0.5 times diffraction efficiency of diffraction-reflected light at θ;
γ(°) is a sum of or difference between θ and Δ, and represents a reflection angle at which diffraction-reflected light is produced with diffraction efficiency equal to or more than 0.5 times diffraction efficiency of the diffraction-reflected light at θ;
δA(°) represents, assuming that the refractive optical element is a triangular prism protruding from the bottom face to form two angles with respect thereto, whichever of those two angles is farther away from the light source; and
δB(°) represents, assuming that the refractive optical element is a triangular prism protruding from the bottom face to form two angles with respect thereto, whichever of those two angles is closer to the light source.

11. The backlight unit according to claim 9, wherein equation (C3) below is fulfilled:
δA<5° Condition (C3)

12. The backlight unit according to claim 10, wherein equation (C3) below is fulfilled:
δA<5° Condition (C3)

13. A liquid crystal display device comprising:
the backlight unit according to claim 2; and
a liquid crystal display panel receiving light from the backlight unit.

14. A liquid crystal display device comprising:
the backlight unit according to claim 3; and
a liquid crystal display panel receiving light from the backlight unit.

15. A liquid crystal display device comprising:
the backlight unit according to claim 4; and
a liquid crystal display panel receiving light from the backlight unit.

16. A liquid crystal display device comprising:
the backlight unit according to claim 5; and
a liquid crystal display panel receiving light from the backlight unit.

17. A liquid crystal display device comprising:
the backlight unit according to claim 6; and
a liquid crystal display panel receiving light from the backlight unit.

18. A liquid crystal display device comprising:
the backlight unit according to claim 8; and
a liquid crystal display panel receiving light from the backlight unit.

19. A liquid crystal display device comprising:
the backlight unit according to claim 9; and
a liquid crystal display panel receiving light from the backlight unit.

20. A liquid crystal display device comprising:
the backlight unit according to claim 10; and
a liquid crystal display panel receiving light from the backlight unit.
